(19) United States
(12) Patent Application Publication
(10) Pub. No.: US 2018/0334099 A1
(43) Pub. Date: Nov. 22, 2018

(54) VEHICLE ENVIRONMENT IMAGING SYSTEMS AND METHODS

(71) Applicant: GM GLOBAL TECHNOLOGY OPERATIONS LLC, Detroit, MI (US)

(72) Inventors: Xiujie GAO, Troy, MI (US); Jinsong WANG, Troy, MI (US); Wende ZHANG, Troy, MI (US); Donald K. GRIMM, Utica, MI (US)

(21) Appl. No.: 15/596,627

(22) Filed: May 16, 2017

(51) Int. Cl. B60R 1/00; H04N 7/18; H04N 5/232; G06T 5/00; G09G 5/10; B60Q 1/08; B60Q 1/30; B60Q 1/32

(52) U.S. Cl. CPC B60R 1/00; B60Q 2300/314; H04N 5/23229; G06T 5/008; G06T 5/009; G09G 5/10; B60Q 1/085; B60Q 1/30; B60Q 1/32; G09G 2380/10; G09G 2360/144; G06T 2207/20208; B60R 2300/105; B60R 2300/301; B60R 2300/303; B60R 2300/406; B60R 2300/8033; B60R 2300/8066; B60R 2300/804; B60R 2300/8086; B60R 2300/103; B60K 2350/106; B60K 2350/1088; B60K 2350/2013; B60K 2350/2069; B60K 2350/352; B60K 2350/357; H04N 7/181

(57) ABSTRACT

A vehicle includes a vision system including at least one external image capture device to transmit image data and a user interface display to present image data received from the at least one image capture device. The vehicle also includes a controller programmed to increase a brightness of an exterior lamp in response to sensing an ambient light level less than an ambient light threshold. The controller is also programmed to modify at least one visual attribute of image data presented at the user interface display in response to an image light level less than a first image light threshold.

### TECHNICAL FIELD

The present disclosure relates to vehicle imaging systems and methods for enhancing display images of vehicle surroundings.

### INTRODUCTION

Vehicles encounter situations and locations having various different visibility levels based on variables of the external environment of the vehicle. Varying visibility can relate to changing lighting levels around the vehicle. Light sensors such as photometric sensors may be limited in obtaining a comprehensive assessment of the visibility of the vehicle environment. Such light sensors may also be unable to account for a dynamically changing vehicle environment, including external objects in the vicinity of a vehicle.

### SUMMARY

A vehicle includes a vision system including at least one external image capture device to transmit image data and a user interface display to present image data received from the at least one image capture device. The vehicle also includes a controller programmed to increase a brightness of an exterior lamp in response to sensing an ambient light level less than an ambient light threshold. The controller is also programmed to modify at least one visual attribute of image data presented at the user interface display in response to an image light level less than a first image light threshold.

A method of presenting image data at a vehicle user interface display includes capturing image data from at least one camera representing a vicinity of the vehicle, and transmitting the image data to a user interface display. The method also includes modifying at least one visual attribute of the image data based on a presented image of the user interface display having an image light level less than a first light threshold. The method further includes increasing a brightness of at least one external lamp in response to an ambient light value less than a second ambient light threshold and presenting an enhanced graphical image at the user interface display.

A vehicle includes at least one image capture device arranged to transmit image data representative of a vicinity of the vehicle, and a user interface display to present image data received from the at least one image capture device. The vehicle also includes a controller programmed to modify at least one visual attribute of a display image based on a difference between a first light level proximate the vehicle and a second light level associated with an upcoming vehicle path.

### BRIEF DESCRIPTION OF THE DRAWINGS

FIG. 1 is a side view of a vehicle having a vision system.

FIG. 2 is a flowchart of a first image enhancement algorithm.

FIG. 3 is a flowchart of a second image enhancement algorithm.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

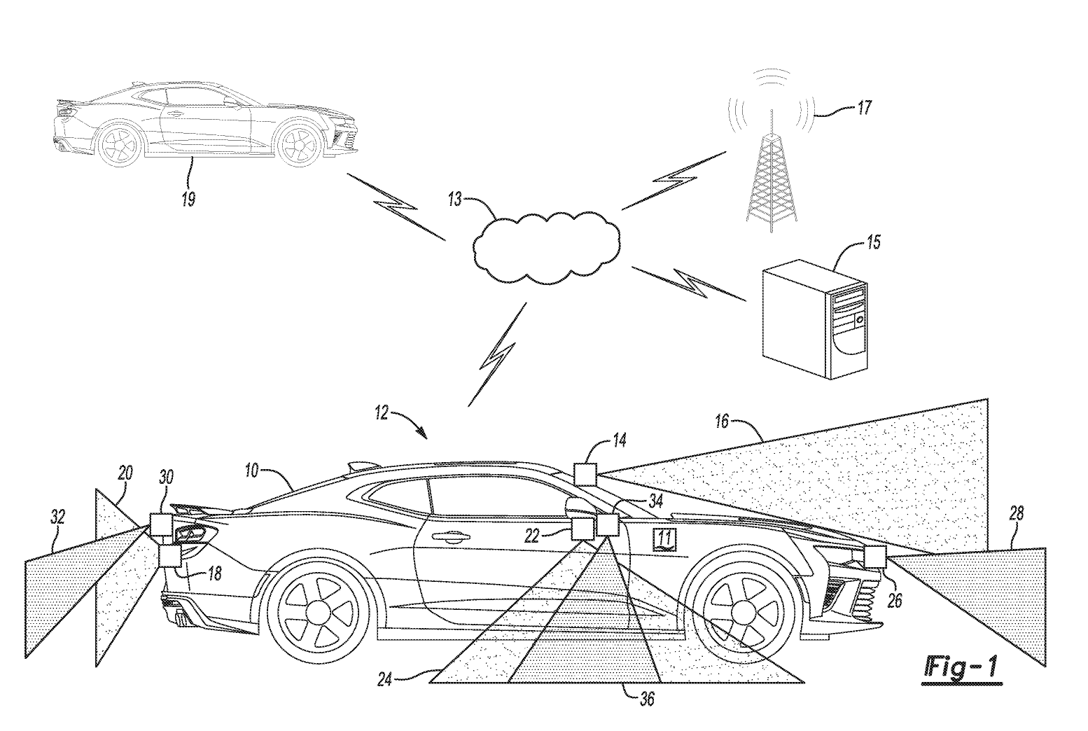

Referring to FIG. 1, a vehicle 10 includes a vision system 12 configured to capture image data in a plurality of regions surrounding the vehicle, including, but not limited to, images in a forward-facing direction, a rearward-facing direction, and/or or images in lateral-facing directions. The vision system 12 includes at least one vision-based imaging device to capture image data corresponding to the exterior of the vehicle 10 for detecting the vehicle surroundings. Each of the vision-based imaging devices is mounted on the vehicle so that images in a desired region of the vehicle vicinity are captured.

A first vision-based imaging device 14 is mounted behind the front windshield for capturing images representing the vehicle's vicinity in an exterior forward direction. In the example of FIG. 1, the first vision-based imaging device 14 is a front-view camera for capturing a forward field-of-view (FOV) 16 of the vehicle 10. In additional examples, an imaging device may be disposed near a vehicle grill, a front fascia, or other location closer to the forward edge of the vehicle. A second vision-based imaging device 18 is mounted at a rear portion of the vehicle to capture images representing the vehicle's vicinity in an exterior rearward direction. According to an example, the second vision-based imaging device 18 is a rear-view camera for capturing a rearward FOV 20 of the vehicle. A third vision-based imaging device 22 is mounted at a side portion of the vehicle to capture images representing the vehicle's vicinity in an exterior lateral direction. According to an example, the third vision-based imaging device 22 is a side-view camera for capturing a lateral FOV 24 of the vehicle. In a more specific example, a side-view camera is mounted on each of opposing sides of the vehicle 10 (e.g. a left side-view camera and a right side-view camera). It should be appreciated that while various FOV's are depicted in the Figures as having certain geometric patterns, actual FOV's may have any number of different geometries according to the type of imaging device which is employed in practice. In some examples, wide angle imaging devices are used to provide wide angle FOV's such as 180 degrees and wider. Additionally, while each of the cameras is depicted as being mounted on the vehicle, alternate examples include external cameras having FOV's which capture the surrounding environment of the vehicle.

The cameras 14, 18, and 22 can be any type of imaging device suitable for the purposes described herein, that are capable of receiving light, or other radiation, and converting the light energy to electrical signals in a pixel format using, for example, charged coupled devices (CCD). Each of the cameras may also be operable to capture images in various regions of the electromagnetic spectrum, including infrared, ultraviolet, or within visible light. The cameras may also be operable to capture digital images and/or video data in any suitable resolution including high-definition. As used in the present disclosure, image data provided by the image capture devices includes either individual images or a stream of video images. The cameras may be any digital video recording device in communication with a processing unit of the vehicle. Image data acquired by the cameras is passed to the vehicle processor for subsequent actions. For example, image data from the cameras 14, 18, and 22 is sent to a processor, or vehicle controller 11, which processes the image data. In the case of external cameras, image data may be wirelessly transmitted to the vehicle controller 11 for use as described in any of the various examples of the present disclosure. As discussed in more detail below, the vehicle processor 11 may be programmed to generate images and other graphics at a user interface display such as, for example, a console screen or at a review mirror display device. In some alternative examples, the user interface display is located off-board of the vehicle such that a remote viewer can access image data acquired by the vision system 12.

The various vision system components discussed herein may have one or more associated controllers to control and monitor operation. The vehicle controller 11, although schematically depicted as a single controller, may be implemented as one controller, or as system of controllers in cooperation to collectively manage the vision system and other vehicle subsystems. Communication between multiple controllers, and communication between controllers, actuators and/or sensors may be accomplished using a direct wired link, a networked communications bus link, a wireless link, a serial peripheral interface bus or any another suitable communications link. Communications includes exchanging data signals in any suitable form, including, for example, electrical signals via a conductive medium, electromagnetic signals via air, optical signals via optical waveguides, and the like. Data signals may include signals representing inputs from sensors, signals representing actuator commands, and communications signals between controllers. In a specific example, multiple controllers communicate with one another via a serial bus (e.g., Controller Area Network (CAN)) or via discrete conductors. The controller 11 includes one or more digital computers each having a microprocessor or central processing unit (CPU), read only memory (ROM), random access memory (RAM), electrically-programmable read only memory (EPROM), a high speed clock, analog-to-digital (A/D) and digital-to-analog (D/A) circuitry, input/output circuitry and devices (I/O), as well as appropriate signal conditioning and buffering circuitry. The controller 11 may also store a number of algorithms or computer executable instructions in non-transient memory that are needed to issue commands to perform actions according to the present disclosure. In some examples algorithms are provided from an external source such as a remote server 15.

The controller 11 is programmed to monitor and coordinate operation of the various vision system components. The controller 11 is in communication with each of the image capturing devices to receive images representing the vicinity of the vehicle and may store the images as necessary to execute exterior lighting diagnosis algorithms described in more detail below. The controller 11 is also in communication with a user interface display in an interior portion of the vehicle 10. In alternate examples the user interface display is located off-board of the vehicle 10 such as at a user mobile device or at a remote monitoring office. The controller is programmed to selectively provide pertinent images to the display to inform viewers about conditions in the vicinity of the vehicle 10. While image capturing devices are described by way of example in reference to the vision system, it should be appreciated that the controller 11 may also be in communication with an array of various sensors to detect external objects and the overall environment of the vehicle. For example, the controller may receive signals from any combination of radar sensors, lidar sensors, infrared sensors, ultrasonic sensors, or other similar types of sensors in conjunction with receiving image data. The collection of data signals output from the various sensors may be fused to generate a more comprehensive perception of the vehicle environment, including detection and tracking of external objects.

The controller 11 may also be capable of wireless communication using a transceiver or similar transmitting device. The transceiver may be configured to exchange signals with a number of off-board components or systems. The controller 11 is programmed to exchange information using a wireless communications network 13. Data may be exchanged with a remote server 15 which may be used to reduce on-board data processing and data storage requirements. In at least one example, the server 15 performs processing related to image processing and analysis. The server may store one or more model-based computation algorithms to perform vehicle security enhancement functions. The controller 11 may further be in communication with a cellular network 17 or satellite to obtain a global positioning system (GPS) location. The controller 11 may also be in direct wireless communication with objects in a vicinity of the vehicle 10. For example, the controller may exchange signals with various external infrastructure devices (i.e., vehicle-to-infrastructure, or V2I communications) and/or a nearby vehicle 19 to provide data acquired from the vision system 12, or receive supplemental image data to further inform the user about the vehicle environment.

The vision system 12 may be used for recognition of road markings, lane markings, road signs, or other roadway objects for inputs to lane departure warning systems and/or clear path detection systems. Identification of road conditions and nearby objects may be provided to the vehicle processor to guide autonomous vehicle guidance. Images captured by the vision system 12 may also be used to distinguish between a daytime lighting condition and a nighttime lighting condition. Identification of the daylight condition may be used in vehicle applications which actuate or switch operating modes based on the sensed lighting condition. As a result, the determination of the lighting condition eliminates the requirement of a dedicated light sensing device while utilizing existing vehicle equipment. In one example, the vehicle processor utilizes at least one captured scene from the vision system 12 for detecting lighting conditions of the captured scene, which is then used as an input to lighting diagnosis procedures.

With continued reference to FIG. 1, the vehicle 10 also includes a plurality of external lamps each configured to emit light in the vehicle vicinity to enhance driver visibility, as well as visibility of vehicle 10 to other vehicles and pedestrians. At least one front exterior lamp 26 emits light in a forward direction of the vehicle 10. The emitted light casts a light pattern 28 in a front portion of the vicinity of the vehicle 10. While a single lamp is schematically depicted in FIG. 1 for illustration purposes, a combination of any number of lamps may contribute to an aggregate light pattern in the front portion of the vicinity of the vehicle 10. For example, the front exterior lamps may include at least low beams, high beams, fog lamps, turn signals, and/or other forward lamp types to cast an aggregate front light pattern 28. Further, the light pattern 28 is cast onto the ground or onto nearby objects in front of the vehicle, and is included in image data captured by the first vision-based imaging device 14.

The vehicle 10 also includes a plurality of rear exterior lamps 30 to emit light in a rearward direction of the vehicle 10. Similar to the front of the vehicle, any number of a combination of lamps may contribute to an aggregate light pattern in the rear portion of the vicinity of the vehicle 10. For example, the rear exterior lamps may include at least rear lamps, brake signal lamps, high-mount lamps, reverse lamps, turn signals, license plate lamps, and/or other rear lamp types to cast an aggregate rear light pattern 32. Further, the light pattern 32 is cast onto the ground or onto nearby objects behind the vehicle, and is included in image data captured by the second vision-based imaging device 18.

The vehicle 10 may further include at least one lateral exterior lamp 34 to emit light in a lateral direction of the vehicle 10. Similar to the front and rear of the vehicle, any number of a combination of lamps may contribute to an aggregate light pattern in a side portion of the vicinity of the vehicle 10. For example, the at least one lateral exterior lamp 34 may include turn signal indicators, side mirror puddle lamps, side marker lamps, ambient lighting, and other types of side lamp to cast an aggregate lateral light pattern 36 which is included in image data captured by the third vision-based imaging device 22. Each of the FOV's of the vision system 12 may capture any combination of the plurality of light patterns emitted from the exterior lamps.

According to aspects of the present disclosure, the controller stores algorithms to enhance images from any of the image capture devices which are presented at the user interface display. Techniques are provided herein that enhance camera visibility when there are substantial changes in lighting conditions (e.g., from dark to light) or during nighttime or other conditions when visibility is compromised. Based on the conditions of the exterior environment of the vehicle certain features appearing in a given image may be more or less readily perceptible to a viewing user. Image enhancement algorithms may include recognizing certain conditions that lead to less than optimal display clarity, and provide a number of image enhancements to improve user perception of key image features.

In some examples, image enhancement algorithms may be initiated by engagement of one or more vehicle states. A vehicle transmission motive state being shifted into reverse drive prompts the display of images received from a rear facing camera. The rear FOV image may include one or more dark areas within the image display such that it is difficult for a viewer to discern particular features of the image. The algorithm includes analyzing the image for visual quality relative to the current environment and modifying one or more visual attributes of the image in response to an image light level less than a first light threshold L1.

Image data received from the cameras are used to directly determine an external light level in areas surrounding the vehicle. For example, a digital image is captured from one or more of the external cameras and is assessed for an external light level. According to some examples, individual pixels of each image are rated according to a brightness scale. The total value of all of the brightness ratings may be summed to obtain an overall vehicle surrounding light level. In other examples, an average of pixel brightness is used to determine an overall light level. The use of multiple cameras as a set of inputs to determine exterior light levels provides the opportunity to derive a more comprehensive assessment as compared to a single scalar light value as would be provided from a single photometric light sensor.

Also, the image enhancement algorithms may include assessing the directionality of light levels from each of a plurality of images. If a first direction FOV image differs from a second FOV image, depending on the context of the vehicle state and the particular image being displayed, the display may be adjusted to account for the differences. For example, a vehicle in a garage shifting into reverse drive state may receive a brighter first rear image from a sunny exterior of the garage, and a darker second forward image facing the interior of the garage. Since the vehicle is in reverse, the reverse image is to be displayed at the user interface display to reflect the upcoming vehicle path. Thus the forward image may be at least partially disregarded when calculating an external light level upon which to provide a display image enhancement. In a second example, a vehicle poised to depart a well-lit garage interior at night into a poorly lit dark area may similarly weigh views of some directions more heavily than other directions. More specifically, an image corresponding to the dark area may require brightening or other visual enhancement regardless of the conditions at the front of the vehicle inside the garage. In a third example, a vehicle in a sunny environment may take into account the direction of the sun when determining whether, and to what degree, to enhance a displayed image. Specifically, a sun load directly on the screen may cause image washout and difficulty for a viewer to see the images displayed. The algorithm may include increasing a brightness level of the displayed image in response to detecting a direction of sun that diminishes visibility of the display of a FOV image.

Once a determination is made regarding a need for image enhancement, any of several responses may be provided to improve view-ability. In some examples, an image may be enhanced at the controller following image acquisition from an image capture device. Once the image is processed for presentation at the user interface display, a light factor associated with the image may be calculated as discussed above. In response to a light factor less than a predetermined light threshold, the algorithm may include implementing one or more image modifications to improve visibility of desired areas.

In some examples, the algorithm may include modifying only local portions of the image as required. That is, lightness factor values may be determined on a region-by-region basis and only those regions requiring enhancement are modified. In this case local shadows or dark spots may be reduced or eliminated improving visibility to the viewer.

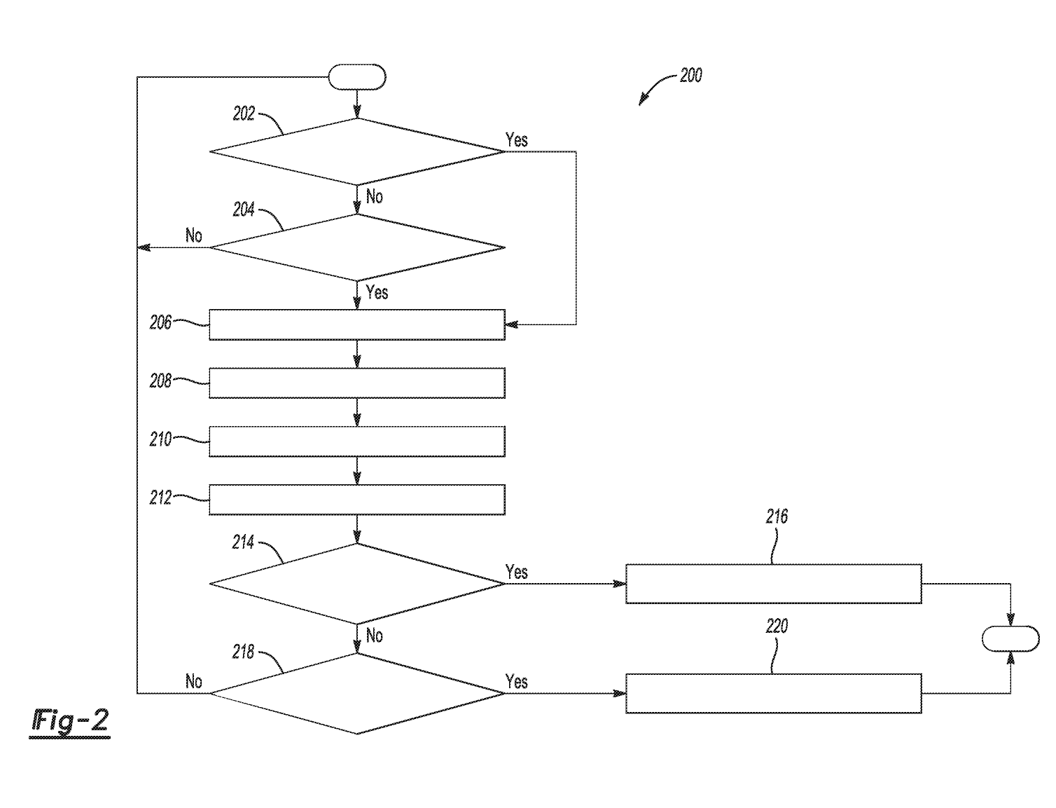

Referring to the flowchart of FIG. 2, an algorithm 200 is depicted for enhancing an image following acquisition. At step 202 the algorithm includes assessing a motive state of the vehicle which may trigger activation of one or more particular external views associated with the motive state. In the example of FIG. 2, a reverse transmission gear being engaged at step 202 triggers acquisition of rear camera image data at step 206. If at step 202 no motive gear is engaged which triggers image acquisition, the algorithm includes assessing whether a diligence mode is engaged at step 204. As discussed in more detail below, the vehicle may acquire images to surveille the vicinity of the vehicle while stationary in response to user input or other sensed vehicle environmental conditions. At step 204 if a diligence mode is engaged, then the algorithm includes acquiring imaged data from one or more cameras at step 206.

After acquiring image data from cameras, the algorithm includes assessing an ambient light level in the vicinity of the vehicle at step 208. At step 210 the algorithm includes assessing a light level in the vicinity of the user interface display screen. The local light level near the display itself may also serve as an input to whether, and to what degree, to increase display brightness, contrast, resolution, or other attributes to improve visibility. At step 212 the algorithm includes presenting at least one FOV image at the user interface display.

At step 214 the algorithm includes calculating an aggregate light level for the image presented at the user interface display. As discussed above, the aggregate light level may be an average brightness of a number of pixels of the digital image. If the aggregate light level is less than a first light threshold L1 at step 214 the algorithm includes performing image enhancement to improve visibility. At step 216 the algorithm includes performing a global enhancement of the image. The image enhancement may include at least one of the following: increasing image brightness, increasing image contrast, increase image resolution, increasing frame rate of the image capture device, increasing camera exposure time, and converting the image to an infrared view.

If at step 214 the aggregate light level of the image is greater than the light threshold L1, the algorithm includes assessing local portions of the image. If there are one or more areas of interest within the image, analysis of those local portions is performed at step 218. Areas of interest may include, for example, the upcoming vehicle path once the vehicle is transmission motive state. In some examples areas of interest may be selected based on detected objects within the field of view. As discussed in more detail below, data output from other vehicle sensors may be fused with image data from the vision system and used to enhance images presented at the user interface display. In some examples, stationary objects within the field of view are considered as areas of interest and a different light threshold L2 is applied to discern whether or not to enhance those local portions of the image containing the area of interest. In alternative examples, moving objects detected within the field of view are selected as areas of interest. At step 218 if a light level of the area of interest is greater than a second light threshold L2, the algorithm may include determining that the image is sufficient to not require image enhancement. However if at step 218 the light level of the area of interest is less than a second light threshold L2, the algorithm includes performing local image enhancement at the area of interest at step 220. According to some examples the second light threshold L2 is greater than the first light threshold L1 to provide greater sensitivity for areas of interest relative to the overall image.

Supplemental illumination may also be applied to external subjects of an image to improve visibility to the viewer. That is, the aggregate light pattern of exterior lamps may be modified to reduce dark spots within the field of view thus enhancing the image as presented at the user interface display. According to some examples, an exterior lamp which was previously deactivated may be activated to increase illumination in areas where the emitted light pattern is within the field of view. In certain more specific use cases, the algorithm may include activating previously deactivated reverse lights when rear cameras are acquiring images although the vehicle may not be in reverse. Similarly, a rear light pattern may be enhanced by activating brake lamps while a rear camera acquires images even though a driver has not depressed the brake pedal. In another example, the algorithm may include activating previously inactive puddle lamps when a side camera provides images even though a vehicle door is not ajar.

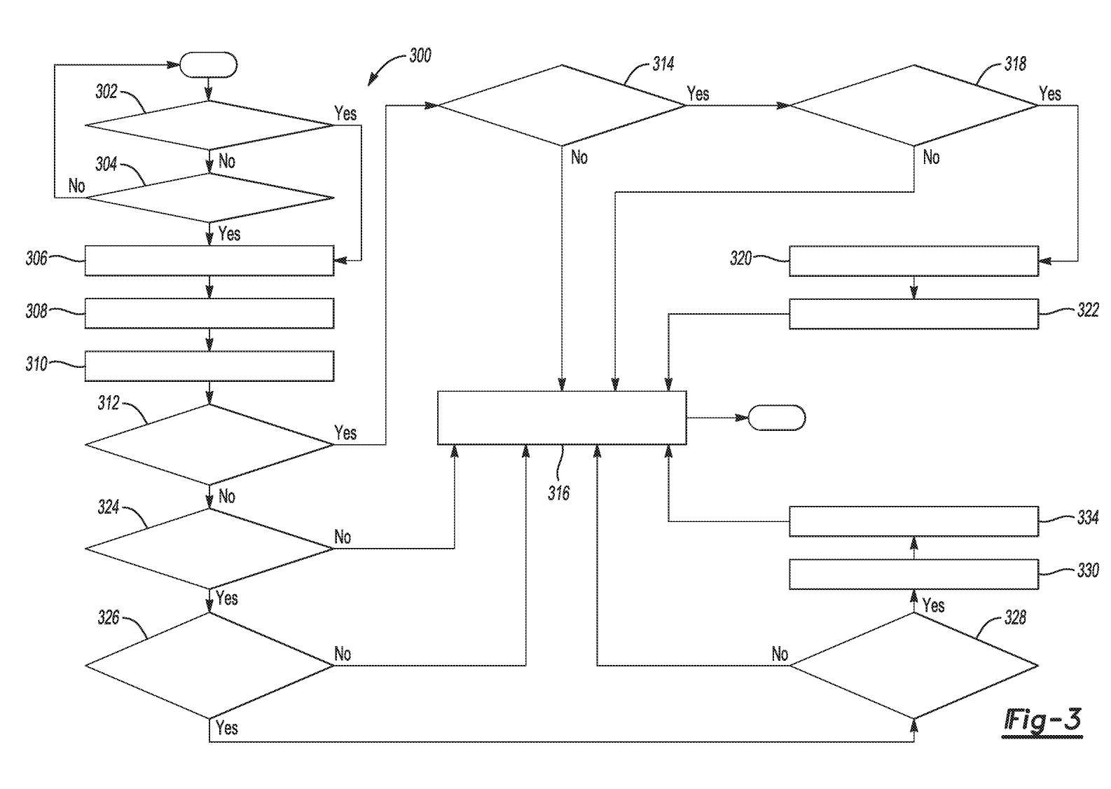

Referring to the flowchart of FIG. 3, an algorithm 300 is depicted for enhancing the visibility of portions of the field of view prior to presenting the image to the user. Similar to examples discussed above, at step 302 the algorithm includes assessing a motive state of the vehicle which may trigger activation of one or more particular external views associated with the motive state. In the example of FIG. 3, a reverse transmission gear being engaged at step 302 triggers acquisition of rear camera image data at step 306. If at step 302 no motive gear is engaged which triggers image acquisition, the algorithm includes assessing whether a diligence mode is engaged at step 304. As discussed in more detail below, the vehicle may acquire images to surveille the vicinity of the vehicle while stationary in response to user input or other sensed vehicle environmental conditions. At step 304 if a diligence mode is engaged, then the algorithm includes acquiring imaged data from one or more cameras at step 306.

After acquiring image data from cameras, the algorithm includes assessing an ambient light level in the vicinity of the vehicle at step 308. At step 310 the algorithm includes assessing a light level in the vicinity of the user interface display screen.

At step 312 an aggregate light level is calculated for an image acquired from a camera. As discussed above, the aggregate light level may be an average brightness of a number of pixels of the digital image. If the aggregate light level is less than a first light threshold L1 at step the algorithm includes assessing whether one or more portions of the external light pattern is within the FOV.

At step 314 the algorithm includes determining whether a light pattern is within a FOV of the acquired image. In some examples, the controller may store predetermined pattern overlays associated with each FOV to indicate the location of light patterns within the corresponding FOV. If none of the external light patterns is within the particular FOV at step 314 the controller may present the FOV image at the user interface display at step 316 without supplementing the light level of the external environment.

If at step 314 one or more light patterns is within the FOV, the algorithm assesses the effect on the visibility of the image from activating one or more lamps. More specifically, at step 318 the algorithm includes assessing whether external lamps having a light pattern within the FOV emit sufficient brightness to improve visibility of the image presented at the user interface display. The controller may evaluate the brightness of the aggregate light pattern versus the ambient light level surrounding the vehicle. If the light pattern brightness is less than the level of ambient light at step 318 the controller may present the FOV image at the user interface display at step 316 without supplementing the light level of the external environment.

If the light pattern brightness exceeds the level of ambient light at step 318, the supplementation of the external light level may enhance the visibility of the relevant image at the user interface display. At step 320 one or more previously-deactivated external lamps are activated to illuminate subject external objects within the FOV. In some examples, brightness of exterior lamps may be adjusted once activated to further enhance visibility of the vehicle's surroundings. At step 322 the algorithm includes increasing the brightness of relevant activated lamps. Once the external illumination is optimized as discussed above the algorithm may include returning to step 316 to present the FOV image at the user interface display.

If at step 312 the overall image light level is greater than the first light threshold L1, the algorithm may include assessing smaller segments of the image as areas of interest. Similar to the examples discussed above, areas of interest may be designated according to detected static objects, moving objects, or using data provided from other vehicle sensors. Once an area of interest is designated for a particular segment of the FOV, the light level of the area of interest is assessed against a brightness threshold. At step 324 the algorithm includes determining whether a light level of the area of interest of the FOV is greater than a second light threshold L2. If at step 324 the light level of the area of interest is greater than L2, the algorithm includes determining that no supplemental external illumination is needed to enhance the image at the user interface display. At step 316 the controller may present the FOV image at the user interface display without supplementing the light level of the external environment.

If at step 324 the light level of the area of interest is less than L2, the algorithm includes assessing at step 326 whether one or more individual lamps emit a light pattern that overlaps the area of interest. If none of the individual lamps emit light which illuminates the area of interest, the algorithm, modifying lamp output may not improve visibility of the area of interest, and at step 316 the controller may present the FOV image at the user interface display without supplementing the light level of the external environment.

If at step 326 one or more light patterns covers the area of interest, the algorithm includes assessing at step 328 whether those particular external lamps having a light pattern covering the area of interest (e.g., lamps x₁, x₂, . . . xᵢ) emit sufficient brightness to improve visibility of the image presented at the user interface. For example, certain exterior lamps may be colored and/or emit less light due to the primary function of the lamp (e.g., red brake lamps, amber turn signal lamps, or moderate brightness license plate lamps). In contrast, other external lamps may emit significant brightness, such as front headlamps for example. If at step 328 none of the exterior lamps emits sufficient brightness to improve lighting at the area of interest, at step 316 the controller may present the FOV image at the user interface display without supplementing the light level of the external environment.

If at step 328 one or more of the exterior lamps (i.e., lamp x₁ through lamp xᵢ) emits a light pattern with sufficient brightness to further illuminate the area of interest, those particular lamps are activated at step 330. In some examples, brightness of exterior lamps may be adjusted following activation to further enhance visibility of the vehicle's surroundings. At step 334 the algorithm includes increasing the brightness of relevant activated lamps. Lamps such as brake lamps, license plate lamps, and mirror puddle lamps which may not otherwise emit bright light may be augmented to illuminate key areas within the FOV when necessary. Once the external illumination is optimized as discussed above the algorithm may include returning to step 316 to present the FOV image at the user interface display.

In alternate examples, a position of one or more headlamps may be changed to redirect light patterns to reduce or eliminate dark portions within a given FOV. In the case of active headlamps having motors to adjust headlamp aim, the headlamps may be redirected within the FOV to focus on areas of interest or dark portions within an image to be presented at the user interface display.

As discussed above, changing a transmission motive state may operate as a trigger to cause display and enhancement of an image corresponding to the path ahead in the current motive state. In some cases, a shift into a reverse gear may cause the algorithm to analyze the lighting level of the upcoming rearward path potentially ignoring certain other portions of the vicinity of the vehicle. For example, departing a well-illuminated garage into a very dark exterior environment, the reverse camera image may be very dark and unintelligible in certain portions. In this case the reverse image is displayed and enhanced as disclosed herein to allow the user to visibly discern the state of the upcoming path.

Also described above, the images at the user interface display may also be enhanced using data provided from one or more of the external sensors. For example, external objects detected by the lidar or radar sensors may be highlighted visually in a given image. Data from the sensors may be merged with the image data from the vision system to add further emphasis to key objects and heighten a user's attention to those objects within a FOV. Thus in cases where image enhancement is limited, additional graphical indicators may be employed to ensure user awareness of external objects in the vicinity of the vehicle. According to some examples, the algorithm may include superimposing a graphical indicator representing a detected external object on the image display in response to an image light level less than a predetermined light threshold.

Data transmitted from external sources may also be used to enhance a display of a FOV. For example, V2X data may be used to indicate one or more objects within a FOV that may not be fully visible due to lighting conditions. Similar to the above example, a graphical indicator representing an external object may be overlaid onto an image provided at the user interface display. V2V communications from other vehicles, V2I communications from infrastructure devices (e.g., signs or other traffic devices), and V2P communications from pedestrian mobile devices may each provide data used to enhance the visibility of the user interface display.

In some examples, the algorithm may allow a user to manually select any of a number of external FOV's by providing input at the user interface display. Any of the particular FOV's selected for display may be visually enhanced by employing any of the techniques discussed herein to automatically improve visibility of the image. In a specific example, a vehicle in a non-motive state allows the user to scroll through any of the available FOVs to manually surveille the surroundings. Dark portions of such images may be enhanced using techniques disclosed herein. The image enhancement algorithms may cooperate with one or more automatic diligence modes to surveille the vehicle surroundings. In some cases, when the car is in a non-motive state, a diligence mode may direct a user's attention to moving objects within any of a number of FOV's. If a particular FOV is highlighted in response to detection of a moving external object, the image may be analyzed for optimal visibility. If there are dark areas are near the vehicle within a FOV, enhancements are applied to improve the image quality. The controller may perform any number image modifications or external lighting changes as discussed above. For example, dark areas of the image may be enhanced to improve visibility. Additionally, external lamps on the side of the vehicle proximate to the detected moving object may be illuminated to enhance the visibility of the relevant local surroundings.

In further examples, the vehicle controller may be programmed to transmit images acquired by the vision system to a remote user interface display. In this way an off-board monitor may observe conditions in the vicinity of the vehicle in order to provide any number of responses. For example, a vehicle owner or other monitor may seek to remotely view external conditions near the vehicle for security purposes. In this case the viewer may be able to respond to any perceived security threats and provide assistance. More specifically, the viewer may be able to provide instructions to the vehicle controller to autonomously depart the location, trigger preemptive alarms at the vehicle, notify authorities, or other security responses. Similar to the examples discussed above, the image data acquired by the vision system for transmission to off-board viewing locations may be enhanced as required to mitigate the effects of low light levels surrounding the vehicle.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a vision system including at least one external image capture device to transmit image data;
a user interface display to present image data received from the at least one image capture device; and
a controller programmed to
increase a brightness of an exterior lamp in response to sensing an ambient light level less than an ambient light threshold,
modify at least one visual attribute of image data presented at the user interface display in response to an image light level less than a first image light threshold.

2. The vehicle of claim 1 wherein the light level is based on image data received from a plurality of image capture devices.

3. The vehicle of claim 1 wherein the image light level is based on a predetermined area of interest within a field of view of the at least one image capture device.

4. The vehicle of claim 3 wherein the area of interest is a segment of the image data selected based on detection of an external object in a vicinity of the vehicle.

5. The vehicle of claim 1 wherein the image light level is based on an average of respective light levels of individual pixels of a digital image.

6. The vehicle of claim 1 wherein the controller is further programmed to select at least one predetermined field of view to present at the user interface display based on a vehicle transmission motive state.

7. The vehicle of claim 1 wherein the controller is further programmed to automatically adjust at least one of a brightness and a contrast of a user display in response to sensing an ambient light level less than a predetermined threshold.

8. The vehicle of claim 1 wherein the at least one visual attribute of image data includes at least one of an image brightness, an image contrast, an image resolution, an image contrast, an image frame rate of the at least one camera, a camera exposure time, and an infrared view of the image.

9. The vehicle of claim 1 wherein the controller is further programmed to superimpose graphical data from at least one object sensor onto image data presented at the user interface display.

10. A method of presenting image data at a vehicle user interface display comprising:
capturing image data from at least one camera representing a vicinity of a vehicle;
transmitting the image data to a user interface display;
modifying at least one visual attribute of the image data based on a presented image of the user interface display having an image light level less than a first light threshold;
increasing a brightness of at least one external lamp in response to an ambient light value less than a second ambient light threshold; and
presenting an enhanced graphical image at the user interface display.

11. The method of claim 10 wherein the enhanced graphical image includes an icon indicative of an external object detected by an object sensor.

12. The method of claim 10 wherein the at least one visual attribute includes at least one of: an image brightness, an image contrast, an image resolution, an image contrast, an image frame rate of the at least one camera, a camera exposure time, and an infrared view of the image.

13. The method of claim 10 further comprising selecting an area of interest within the image data, and modifying at least one visual attribute of a local portion of the image data based on the area of interest having an image light level less than a second light threshold.

14. The method of claim 10 further comprising selecting at least one predetermined field of view to present at the user interface display based on a vehicle transmission motive state.

15. The method of claim 10 wherein the user interface display is located off-board of the vehicle.

16. A vehicle comprising:
at least one image capture device arranged to transmit image data representative of a vicinity of the vehicle;
a user interface display to present image data received from the at least one image capture device; and
a controller programmed to
modify at least one visual attribute of a display image based on a difference between a first light level proximate the vehicle and a second light level associated with an upcoming vehicle path.

17. The vehicle of claim 16 wherein the controller is further programmed to determine the upcoming vehicle path based on a vehicle transmission motive state.

18. The vehicle of claim 16 wherein the controller is further programmed to activate an external lamp to emit a light pattern upon the upcoming vehicle path in response to the second light level being less than an ambient light level threshold.

19. The vehicle of claim 16 wherein the controller is further programmed to modify at least one visual attribute of the display image in response to detection of an external object within the vicinity of the vehicle.

20. The vehicle of claim 16 wherein the at least one visual attribute of the display image includes at least one of an image brightness, an image contrast, an image resolution, an image contrast, an image frame rate of the at least one camera, a camera exposure time, and an infrared view of the image.
